(19) United States
(12) Patent Application Publication
(10) Pub. No.: US 2026/0274266 A1
(43) Pub. Date: Sep. 17, 2026

(54) VEHICLE SUGGESTION APPARATUS, VEHICLE SUGGESTION METHOD, AND VEHICLE SUGGESTION PROGRAM

(71) Applicants: DENSO CORPORATION, Kariya-city (JP); J-QuAD DYNAMICS Inc., Tokyo (JP)

(72) Inventor: Hiroki ONO, Tokyo (JP)

(21) Appl. No.: 19/563,677

(22) Filed: Mar. 11, 2026

(30) Foreign Application Priority Data
Mar. 13, 2025 (JP) 2025-040320

(51) Int. Cl. B60W 30/18; B60W 50/08

(52) U.S. Cl. CPC B60W 30/18163; B60W 50/08; B60W 2552/10

(57) ABSTRACT

A vehicle suggestion apparatus is provided. The vehicle suggestion apparatus acquires stored data including a stored route that is a route stored when a vehicle is traveling, and a merging route that is a route that merges the vehicle onto the stored route from a current position of the vehicle. In response to an evaluation distance being less than an evaluation distance threshold, the vehicle suggestion apparatus makes a suggestion to automatically control a behavior of the vehicle. The evaluation distance is a distance from a position on the merging route to a position on the stored route closest to the position on the merging route. While the suggestion is being made, the vehicle suggestion apparatus continues the suggestion in response to the evaluation distance being equal to or less than a continuation distance threshold that is greater than the evaluation distance threshold.

### CROSS-REFERENCE TO RELATED APPLICATIONS

This application is based on and claims the benefit of priority from Japanese Patent Application No. 2025-040320, filed on Mar. 13, 2025. The entire disclosure of the above application is incorporated herein by reference.

### BACKGROUND

### Technical Field

The present disclosure relates to a vehicle suggestion apparatus, a vehicle suggestion method, and a vehicle suggestion program.

### Related Art

A parking assistance system that includes a parking space detecting unit, a deriving unit, a predicting unit, and a determining unit is known. The parking space detecting unit detects a parking space. The deriving unit derives a first required time required to automatically park a vehicle in the parking space. The predicting unit predicts a second required time required for the driver to manually park the vehicle in the parking space based on an amount of time required when the driver previously manually parked the vehicle in a parking space that is the same as or similar to the parking space. The determining unit determines whether to suggest use of automatic parking to the driver based on a result of comparison between the first required time and the second required time.

### SUMMARY

One aspect of the present disclosure provides a vehicle suggestion apparatus. The vehicle suggestion apparatus acquires stored data including a stored route that is a route stored when a vehicle is traveling, and a merging route that is a route that merges the vehicle onto the stored route from a current position of the vehicle. In response to an evaluation distance being less than an evaluation distance threshold, the vehicle suggestion apparatus makes a suggestion to automatically control a behavior of the vehicle. The evaluation distance is a distance from a position on the merging route to a position on the stored route closest to the position on the merging route. While the suggestion is being made, the vehicle suggestion apparatus continues the suggestion in response to the evaluation distance being equal to or less than a continuation distance threshold that is greater than the evaluation distance threshold.

### BRIEF DESCRIPTION OF THE DRAWINGS

In the accompanying drawings:

FIG. 1 is a configuration diagram illustrating a vehicle in which a vehicle suggestion apparatus according to a first embodiment is used;

FIG. 2 is a diagram illustrating a process performed by a vehicle information estimating unit of the vehicle;

FIG. 3 is a diagram illustrating a process performed by a stored data generation unit of the vehicle;

FIG. 4 is a flowchart illustrating processes by the vehicle suggestion apparatus;

FIG. 5 is a diagram illustrating a process performed by the vehicle suggestion apparatus;

FIG. 6 is a diagram illustrating a process performed by the vehicle suggestion apparatus;

FIG. 7 is a flowchart illustrating a suggestion process of a comparative example;

FIG. 8 is a diagram illustrating the suggestion process of the comparative example;

FIG. 9 is a diagram illustrating a process performed by the vehicle suggestion apparatus;

FIG. 10 is a diagram illustrating a vehicle, a current angle, a stored route, and a merging route;

FIG. 11 is a flowchart illustrating processes performed by a vehicle suggestion apparatus according to a second embodiment;

FIG. 12 is a diagram illustrating an angle difference that is a difference between the current angle and a stored angle;

FIG. 13 is a diagram illustrating the angle difference that is the difference between the current angle and the stored angle;

FIG. 14 is a diagram illustrating a process performed by a vehicle suggestion apparatus according to a third embodiment;

FIG. 15 is a flowchart illustrating processes performed by the vehicle suggestion apparatus;

FIG. 16 is a flowchart illustrating processes performed by vehicle suggestion apparatus according to a fourth embodiment;

FIG. 17 is a flowchart illustrating processes performed by vehicle suggestion apparatus according to a fifth embodiment; and

FIG. 18 is a flowchart illustrating processes performed by vehicle suggestion apparatus according to a sixth embodiment.

### DESCRIPTION OF THE EMBODIMENTS

As described in JP 2023-162704 A, a parking assistance system that includes a parking space detecting unit, a deriving unit, a predicting unit, and a determining unit is known. The parking space detecting unit detects a parking space. The deriving unit derives a first required time required to automatically park a vehicle in the parking space. The predicting unit predicts a second required time required for the driver to manually park the vehicle in the parking space based on an amount of time required when the driver previously manually parked the vehicle in a parking space that is the same as or similar to the parking space. The determining unit determines whether to suggest use of automatic parking to the driver based on a result of comparison between the first required time and the second required time.

In a parking assistance system such as that described in JP 2023-162704 A, the driver of the vehicle is notified of the suggestion to automatically control a behavior of the vehicle by screen display or sound. At this time, duration of the suggestion may be short. Should the duration of the suggestion be short, the driver will not easily notice the suggestion since their focus is on driving the vehicle. Therefore, the suggestion is not easily used. Consequently, in the parking assistance system such as that described in JP 2023-162704 A, frequency of use of the suggestion decreases.

It is thus desired to provide a vehicle suggestion apparatus that suppresses decrease in frequency of use of a suggestion to automatically control a behavior of a vehicle, a vehicle suggestion method, and a vehicle suggestion program.

One exemplary embodiment of the present disclosure provides a vehicle suggestion apparatus including: an acquiring unit that acquires stored data including a stored route that is a route stored when a vehicle is traveling, and a merging route that is a route that merges the vehicle onto the stored route from a current position of the vehicle; a suggesting unit that makes a suggestion to automatically control a behavior of the vehicle in response to an evaluation distance being less than an evaluation distance threshold, the evaluation distance being a distance from a position on the merging route to a position on the stored route closest to the position on the merging route; and a continuing unit that continues the suggestion in response to the evaluation distance being equal to or less than a continuation distance threshold that is greater than the evaluation distance threshold, while the suggestion is being made.

As a result, the suggestion is easily continued compared to when only the evaluation distance threshold is used. Therefore, shortening of a duration of the suggestion is suppressed. Consequently, decrease in frequency of use of the suggestion to automatically control the behavior of the vehicle is suppressed.

Here, reference numbers in parentheses attached to the constituent elements and the like indicate examples of corresponding relationships between the constituent elements and the like and specific constituent elements and the like described according to the embodiments described hereafter.

Embodiments will hereinafter be described with reference to the drawings. Here, according to the embodiments below, sections that are identical or equivalent to each other are given the same reference numbers. Descriptions thereof are omitted.

### First Embodiment

A vehicle suggestion apparatus that executes a vehicle suggestion method and a vehicle suggestion program according to a present embodiment suppresses decrease in frequency of use of a suggestion to automatically control a behavior of a vehicle. First, a vehicle in which the vehicle suggestion apparatus is used will be described.

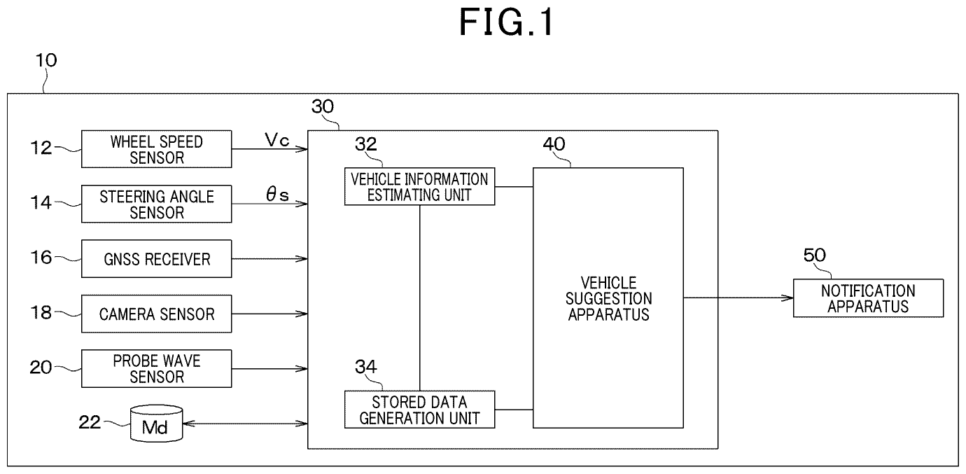

As shown in FIG. 1, a vehicle 10 includes a drive source such as an engine or a motor, and thereby travels on a road. The vehicle 10 includes a wheel speed sensor 12, a steering angle sensor 14, a global navigation satellite system (GNSS) receiver 16, a camera sensor 18, a probe wave sensor 20, a storage apparatus 22, an electronic control unit (ECU) 30, and a notification apparatus 50.

The wheel speed sensor 12 detects a rotation speed of a wheel of the vehicle 10. The wheel speed sensor 12 thereby detects a vehicle speed Vc. In addition, the wheel speed sensor 12 transmits a signal corresponding to the detected vehicle speed Vc to the ECU 30, described hereafter. The vehicle speed Vc is a speed of the vehicle 10.

For example, the steering angle sensor 14 may be attached to a steering rod of the vehicle 10. In addition, the steering angle sensor 14 transmits a signal corresponding to a steering angle θs of a steering wheel accompanying operation by a driver of the vehicle 10 to the ECU 30, described hereafter.

The GNSS receiver 16 receives signals from a plurality of positioning satellites (not shown). In addition, the GNSS receiver 16 estimates a GNSS position of the vehicle 10 based on the received signals. Furthermore, the GNSS receiver 16 transmits a signal corresponding to the estimated GNSS position to the ECU 30, described hereafter. Here, the positioning satellites used by the GNSS receiver 16 may include, for example, global positioning system (GPS) satellites, Globalnaya Navigatsionnaya Sputnikovaya Sistema (GLONASS) satellites, Galileo satellites, and Quasi-Zenith satellites.

The camera sensor 18 include a camera and an image processing unit (not shown). The camera is a monocular camera or a stereo camera, and captures an image of an area surrounding the vehicle 10. The image processing unit extracts a feature point from the image captured by the camera. In addition, the image processing unit transmits the extracted feature point together with the image captured by the camera to the ECU 30, described hereafter.

The probe wave sensor 20 transmits a probe wave such as a millimeter wave, a sonar wave, and an infrared wave to a surrounding object of the vehicle 10. In addition, the probe wave sensor 20 receives a probe wave reflected by the object. The probe wave sensor 20 also acquires data related to a reflection point of the surrounding object from the received probe wave. Furthermore, the probe wave sensor 20 transmits the acquired data related to the reflection point of the surrounding object to the ECU 30, described hereafter.

The storage apparatus 22 includes a non-volatile memory such as a flash memory. In addition, the storage apparatus 22 stores stored data Md generated by the ECU 30, described hereafter.

The ECU 30 is mainly configured by a microcomputer or the like, and includes a central processing unit (CPU), a read-only memory (ROM), a flash memory, a random access memory (RAM), an input/output (I/O), a communication interface, a bus line connecting these components, and the like. In addition, the ECU 30 includes a vehicle information estimating unit 32, a stored data generation unit 34, and a vehicle suggestion apparatus 40 as functional blocks.

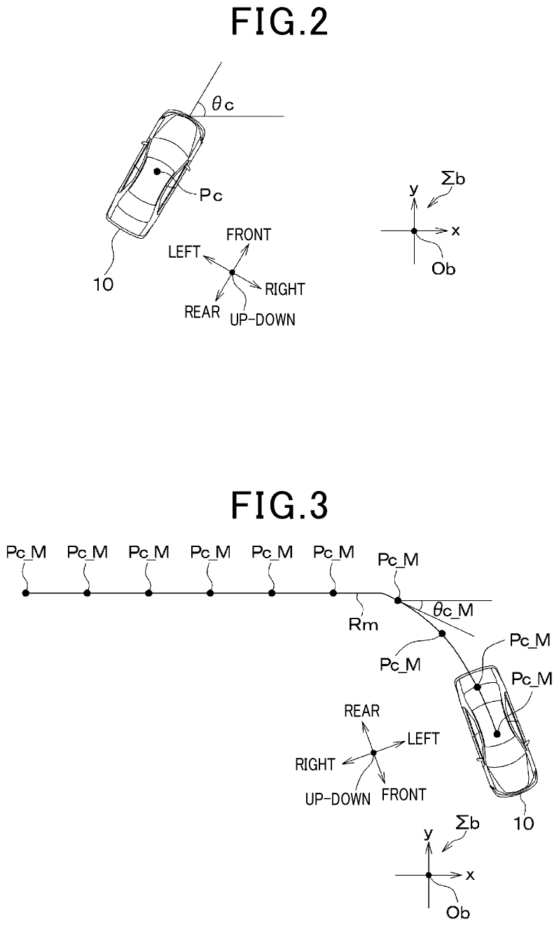

Here, as shown in FIG. 2, a coordinate system in which an axis extending in one direction perpendicular to an up-down direction of the vehicle 10 is an x-axis, and an axis extending in a direction perpendicular to the x-axis is a y-axis, is a reference coordinate system Σb. A point of origin Ob of the reference coordinate system Σb is arbitrarily set. A position of the vehicle 10 relative to the point of origin Ob of the reference coordinate system Σb is a vehicle position Pc. For example, the vehicle position Pc may be a center position of the vehicle 10 relative to the point of origin Ob of the reference coordinate system Σb. An angle formed by a reference line extending in a direction perpendicular to the up-down direction of the vehicle 10, and a straight line extending in a direction perpendicular to the up-down direction of the vehicle 10 and in an advancing direction of the vehicle 10, is a vehicle angle θc. The reference line herein is a straight line parallel to the x-axis.

The vehicle information estimating unit 32 executes a program stored in the ROM of the ECU 30. As a result, the vehicle information estimating unit 32 acquires the vehicle speed Vc from the wheel speed sensor 12. The vehicle information estimating unit 32 also acquires the steering angle θs from the steering angle sensor 14. In addition, the vehicle information estimating unit 32 estimates the current vehicle position Pc and vehicle angle θc from the acquired vehicle speed Vc and steering angle θs and previously estimated vehicle position Pc and vehicle angle θc. Furthermore, the vehicle information estimating unit 32 transmits signals corresponding to the estimated vehicle position Pc and vehicle angle θc to the stored data generation unit 34 and the vehicle suggestion apparatus 40, described hereafter, as vehicle information.

Returning to FIG. 1, the stored data generation unit 34 executes a program stored in the ROM of the ECU 30. For example, the stored data generation unit 34 may execute the program when the driver of the vehicle 10 presses a registration switch (not shown). As a result, the stored data generation unit 34 acquires the vehicle position Pc and the vehicle angle θc from the vehicle information estimating unit 32. The stored data generation unit 34 also acquires the GNSS position from the GNSS receiver 16. The stored data generation unit 34 also acquires the image captured by the camera and the feature point of the captured image from the camera sensor 18. The stored data generation unit 34 also acquires data related to the reflection point of the surrounding object from the probe wave sensor 20.

In addition, as shown in FIG. 3, the stored data generation unit 34 generates a stored route Rm, with each vehicle position Pc when the vehicle 10 is traveling as a stored position Pc_M and the vehicle angle θc corresponding to the vehicle position Pc as a stored angle θc_M. The stored route Rm is a route that is stored when the vehicle 10 is traveling. The stored data generation unit 34 associates each stored position Pc_M with the GNSS position corresponding to that stored position Pc_M. The stored data generation unit 34 also associates each stored position Pc_M with the image captured by the camera and the feature point of the captured image corresponding to the stored position Pc_M. The stored data generation unit 34 also associates each stored position Pc_M with the data related to the reflection point of the surrounding object corresponding to that stored position Pc_M. The stored data generation unit 34 thereby generates stored data Md including the stored route Rm, the stored position Pc_M, the stored angle θc_M, the image captured by the camera and the feature point of the captured image, and the data on the reflection point of the surrounding object.

Returning to FIG. 1, the stored data generation unit 34 transmits the generated stored data Md to the storage apparatus 22. As a result, the stored data Md is stored in the storage apparatus 22. In addition, the stored data generation unit 34 acquires the stored data Md accumulated in the storage apparatus 22 from the storage apparatus 22. The stored data generation unit 34 transmits the accumulated stored data Md to the vehicle suggestion apparatus 40, described hereafter.

The vehicle suggestion apparatus 40 executes a program stored in the ROM of the ECU 30. As a result, the vehicle suggestion apparatus 40 acquires the current vehicle speed Vc from the wheel speed sensor 12. The vehicle suggestion apparatus 40 also acquires the current steering angle θs from the steering angle sensor 14. The vehicle suggestion apparatus 40 also acquires the current GNSS position from the GNSS receiver 16. The vehicle suggestion apparatus 40 also acquires the current image captured by the camera and the feature point of the captured image from the camera sensor 18. The vehicle suggestion apparatus 40 also acquires the data on the current reflection point of the surrounding object from the probe wave sensor 20. The vehicle suggestion apparatus 40 also acquires the current vehicle position Pc and vehicle angle θc from the vehicle information estimating unit 32. The vehicle suggestion device 40 also acquires the accumulated stored data Md from the stored data generation unit 34.

The vehicle suggestion apparatus 40 makes a suggestion based on the acquired information. The Content of the suggestion is to automatically control a behavior of the vehicle 10. The automatic control of the behavior of the vehicle 10 is autonomous driving in which the vehicle 10 travels along the stored route Rm, and in this case, for example, may be automatic parking. The vehicle suggestion apparatus 40 then transmits a signal to the notification apparatus 50, described hereafter, to notify the driver of the vehicle 10 of the suggestion. The suggestion made by the vehicle suggestion apparatus 40 will be described hereafter.

Upon receiving the signal from the vehicle suggestion apparatus 40, the notification apparatus 50 notifies the driver of the vehicle 10 of the suggestion made by the vehicle suggestion apparatus 40 using text display, sound, and light.

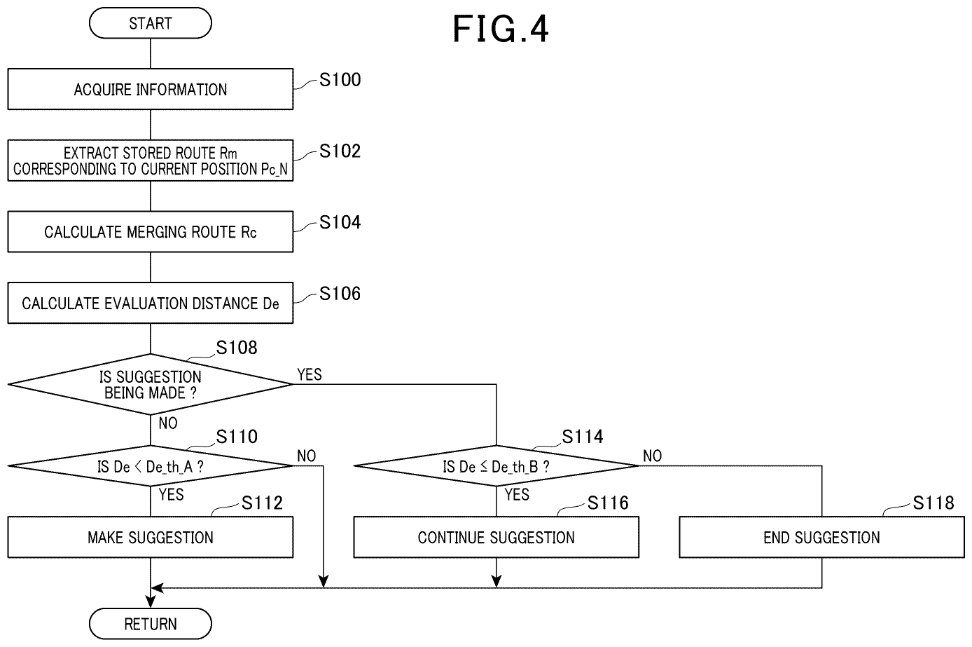

The vehicle 10 in which the vehicle suggestion apparatus 40 according to the first embodiment is used is configured as described above. Next, the suggestion made by the vehicle suggestion apparatus 40 through execution of the program by the vehicle suggestion apparatus 40 will be described with reference to a flowchart in FIG. 4. Here, the program of the vehicle suggestion apparatus 40 may be executed, for example, when power of the vehicle 10 is turned on.

At step S100, the vehicle suggestion apparatus 40 acquires various pieces of information. Specifically, the vehicle suggestion apparatus 40 acquires the current vehicle speed Vc from the wheel speed sensor 12. The vehicle suggestion apparatus 40 also acquires the current steering angle θs from the steering angle sensor 14. The vehicle suggestion apparatus 40 also acquires the current GNSS position from the GNSS receiver 16. The vehicle suggestion apparatus 40 also acquires the current image captured by the camera and feature point of the captured image from the camera sensor 18. The vehicle suggestion apparatus 40 also acquires the current data on the reflection point of the surrounding object from the probe wave sensor 20. The vehicle suggestion device 40 also acquires the current vehicle position Pc as a current position Pc_N and the current vehicle angle θc as a current angle θc_N from the vehicle information estimating unit 32. The vehicle suggestion device 40 also acquires the accumulated stored data Md from the stored data generation unit 34.

At step S102 following step S100, the vehicle suggestion apparatus 40 extracts the stored route Rm corresponding to the current position Pc_N acquired at step S100 from the stored data Md acquired at step S100, as shown in FIG. 5.

For example, the vehicle suggestion apparatus 40 may compare the current GNSS position, image captured by the camera, feature point of the captured image, and data related to the reflection point of the surrounding object acquired at step S100 with the stored data Md acquired at step S100. The vehicle suggestion apparatus 40 thereby extracts the GNSS position, the image captured by the camera, the feature point of the captured image, and the data related to the reflection point of the surrounding object that are the same as or similar to the current information acquired at step S100 from the stored data Md. In addition, the vehicle suggestion apparatus 40 extracts the stored position Pc_M and the stored angle θc_M associated with the extracted GNSS position, image captured by the camera, feature point of the captured image, and data related to the reflection point of the surrounding object from the stored data Md. The vehicle suggestion apparatus 40 thereby extracts the stored route Rm corresponding to the current position Pc_N. Here, when the vehicle suggestion apparatus 40 determines that the stored data Md does not include the GNSS position, the image captured by the camera, the feature point of the captured image, or the data related to the reflection point of the surrounding object that are the same as or similar to the current information, the process performed by the vehicle suggestion apparatus 40 may return to step S100. The GNSS position, the image captured by the camera, the feature point of the captured image, and the data related to the reflection point of the surrounding object that are the same as or similar to the current information refers to a difference in values of the corresponding information being equal to or less than a threshold. The threshold is set by experiments, simulations, and the like, such that information that is the same as or similar to the current information is extracted.

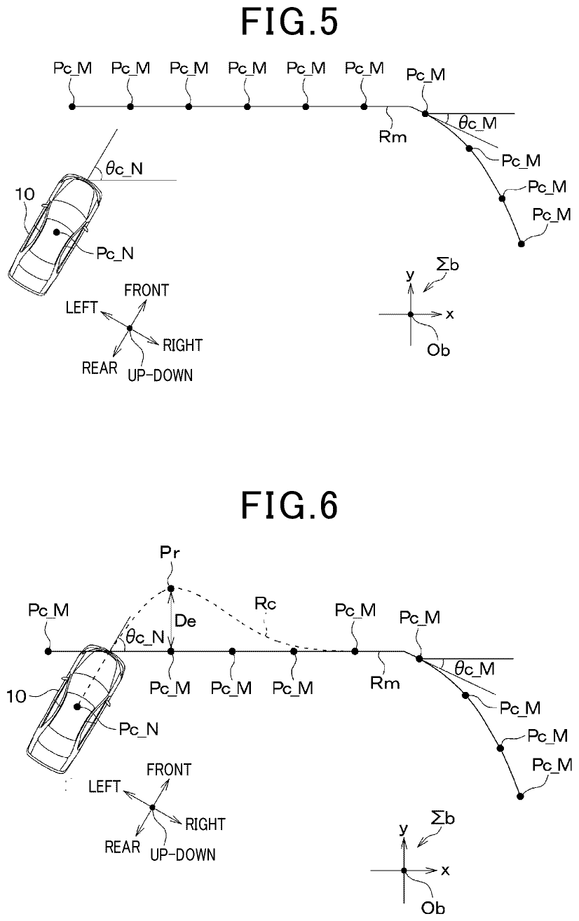

At step S104 following step S102 in the flowchart in FIG. 4, the vehicle suggestion apparatus 40 uses the vehicle speed Vc, the steering angle θs, the current position Pc_N, and the current angle θc_N acquired at step S100, and the stored path Rm extracted at step S102. In addition, the vehicle suggestion apparatus 40 uses a route search method such as a minimum jerk model and a state lattice method. The vehicle suggestion apparatus 40 thereby calculates a merging route Rc and a merging route position Pr as shown in FIG. 6. The merging route Rc is a route merging the vehicle 10 onto the stored route Rm from the current position Pc_N. The merging route position Pr is a predicted position of the vehicle 10 when traveling on the merging route Rc.

At step S106 following step S104 in the flowchart in FIG. 4, the vehicle suggestion apparatus 40 uses the stored route Rm extracted at step S102, and the merging route Rc and the merging route position Pr calculated at step S104. As a result, the vehicle suggestion apparatus 40 calculates an evaluation distance De as shown in FIG. 6. The evaluation distance De is a maximum distance from the merging route position Pr to the stored position Pc_M on the stored route Rm that is closest to the merging route position Pr.

At step S108 following step S106 in the flowchart in FIG. 4, the vehicle suggestion apparatus 40 determines whether the suggestion at step S112, described hereafter, is made.

When the suggestion is determined to be made, the process performed by the vehicle suggestion apparatus 40 proceeds to step S114. In addition, when the suggestion is determined not to be made, the process performed by the vehicle suggestion apparatus 40 proceeds to step S110.

At step S110 following step S108, the vehicle suggestion apparatus 40 determines whether the evaluation distance De calculated at step S106 is less than an evaluation distance threshold De_th_A. The vehicle suggestion apparatus 40 thereby determines whether the suggestion to automatically control the behavior of the vehicle 10 is to be made. Here, the evaluation distance threshold De_th_A is set by experiments, simulations, and the like, such that the suggestion by the vehicle suggestion apparatus 40 is suitably made.

When determined that the evaluation distance De is equal to or greater than the evaluation distance threshold De_th_A, the vehicle suggestion apparatus 40 determines that the suggestion to automatically control the behavior of the vehicle 10 is not to be made. Subsequently, the process performed by the vehicle suggestion apparatus 40 returns to step S100. In addition, when determined that the evaluation distance De is less than the evaluation distance threshold De_th_A, the vehicle suggestion apparatus 40 determines that the suggestion to automatically control the behavior of the vehicle 10 is to be made. Subsequently, the process performed by the vehicle suggestion apparatus 40 proceeds to step S112.

At step S112 following step S110, the vehicle suggestion apparatus 40 transmits the signal notifying the driver of the vehicle 10 of the suggestion to the notification apparatus 50. The vehicle suggestion apparatus 40 thereby makes the suggestion. Upon receiving the signal from the vehicle suggestion apparatus 40, the notification apparatus 50 notifies the driver of the vehicle 10 of the suggestion made by the vehicle suggestion apparatus 40 using text display, sound, and light. Subsequently, the process performed by the vehicle suggestion apparatus 40 returns to step S100.

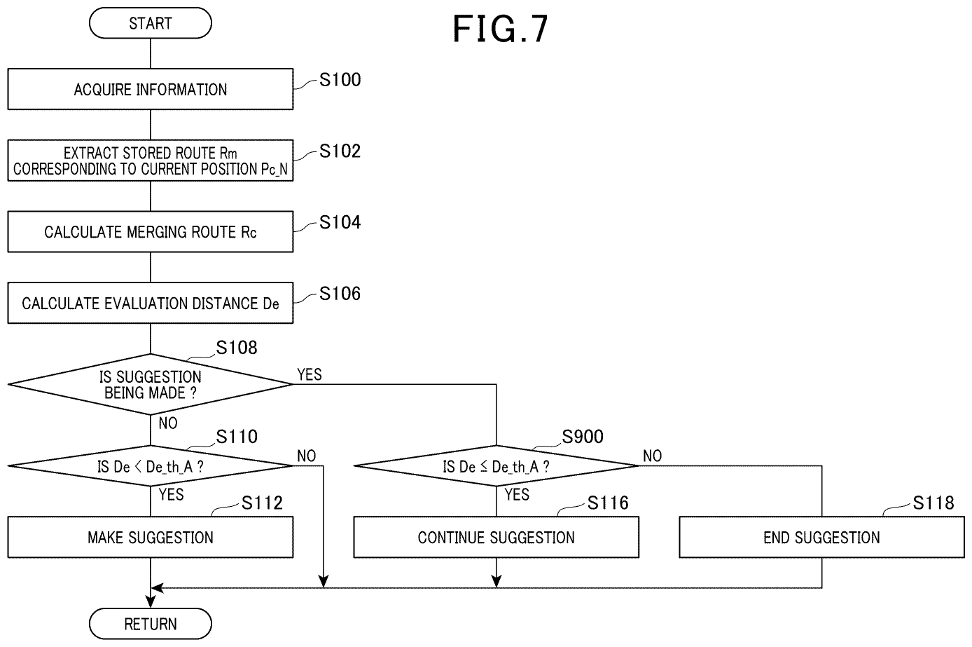

Here, as a comparative example, as shown at step S900 following step S108 in a flowchart in FIG. 7, should the evaluation distance De be equal to or greater than the evaluation distance threshold De_th_A when the suggestion is being made, the suggestion being made may be ended.

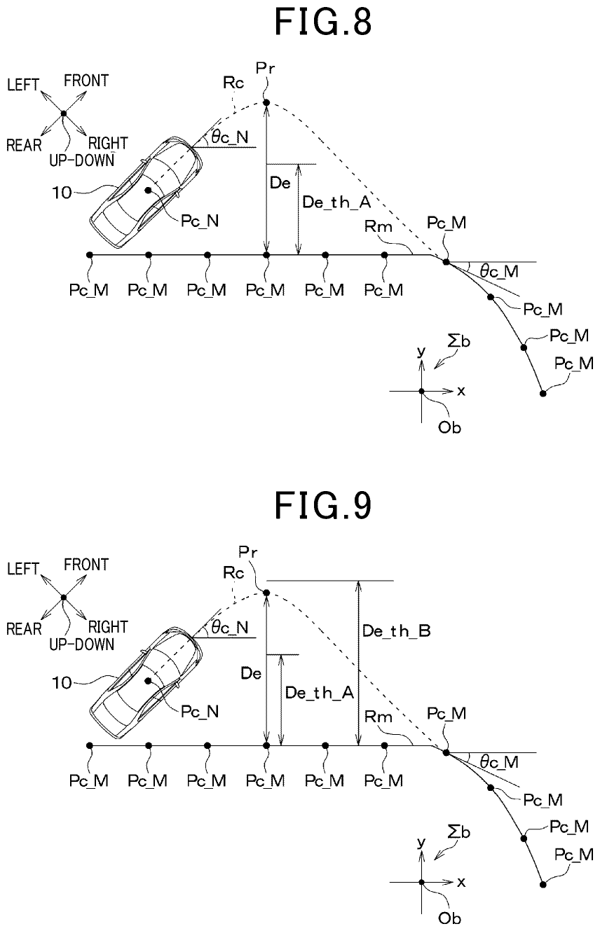

At this time, as shown in FIG. 8, the suggestion may be ended by the vehicle 10 moving from the current position Pc_N, and the duration of the suggestion may be short. The driver of the vehicle 10 does not easily notice the suggestion since their focus is on driving the vehicle 10. Therefore, the suggestion is not easily used. Consequently, frequency of use of suggestions decreases.

Therefore, at step S114 following step S108 in the flowchart in FIG. 4, while the suggestion at step S112 is being made, the vehicle suggestion apparatus 40 determines whether the evaluation distance De calculated at step S106 is equal to or less than a continuation distance threshold De_th_B. The vehicle suggestion apparatus 40 thereby determines whether the suggestion that is being made is to be continued. Here, as shown in FIG. 9, the continuation distance threshold De_th_B is greater than the evaluation distance threshold De_th_A. Therefore, continuation of the suggestion is made easier by the continuation distance threshold De_th_B. Thus, the continuation distance threshold De_th_B is set by experiments, simulations, and the like, such that continuation of the suggestion is made easier.

Then, when determined that the evaluation distance De is greater than the continuation distance threshold De_th_B, the vehicle suggestion apparatus 40 determines that the suggestion that is being made is not to be continued, that is, the suggestion that is being made is to be ended. Subsequently, the process performed by the vehicle suggestion apparatus 40 proceeds to step S118. In addition, when determined that the evaluation distance De is equal to or less than the continuation distance threshold De_th_B, the vehicle suggestion apparatus 40 determines that the suggestion that is being made is to be continued. Subsequently, the process performed by the vehicle suggestion apparatus 40 proceeds to step S116.

At step S116 following step S114 in the flowchart in FIG. 4, the vehicle suggestion apparatus 40 continues transmitting the signal to the notification apparatus 50. As a result, the notification apparatus 50 continues to notify the driver of the vehicle 10 of the suggestion made by the vehicle suggestion apparatus 40. Subsequently, the process performed by the vehicle suggestion apparatus 40 returns to step S100.

At step S118 following step S114, the vehicle suggestion apparatus 40 stops transmitting the signal to the notification apparatus 50. As a result, the notification apparatus 50 stops notifying the driver of the vehicle 10 of the suggestion made by the vehicle suggestion apparatus 40. The suggestion by the vehicle suggestion apparatus 40 is thereby ended. Subsequently, the processes of the vehicle suggestion apparatus 40 returns to step S100.

The vehicle suggestion apparatus 40 makes the suggestion as described above. Next, the vehicle suggestion apparatus 40 suppressing decrease in the frequency of use of the suggestion to automatically control the behavior of the vehicle 10 will be described.

The vehicle suggestion apparatus 40 serves as an acquiring unit that acquires the stored data Md including the stored route Rm and the merging route Rc at step S100, step S102, and step S104. In addition, the vehicle suggestion apparatus 40 serves as a suggesting unit that makes the suggestion to automatically control the behavior of the vehicle 10 when the evaluation distance De is less than the evaluation distance threshold De_th_A at step S110 and step S112. Furthermore, the vehicle suggestion apparatus 40 serves as a continuing unit that continues the suggestion when the evaluation distance De is equal to or less than the continuation distance threshold De_th_B while the suggestion is being made at step S108, step S114, and step S116.

As a result, the suggestion is easily continued compared to when only the evaluation distance threshold De_th_A is used. Therefore, the duration of the suggestion is suppressed from becoming shorter. Consequently, decrease in the frequency of use of the suggestion to automatically control the behavior of the vehicle 10 is suppressed.

### Second Embodiment

According to a second embodiment, the processes at step S110 and step S114 of the vehicle suggestion apparatus 40 differ from those according to the first embodiment. Other configurations are similar to those according to the first embodiment.

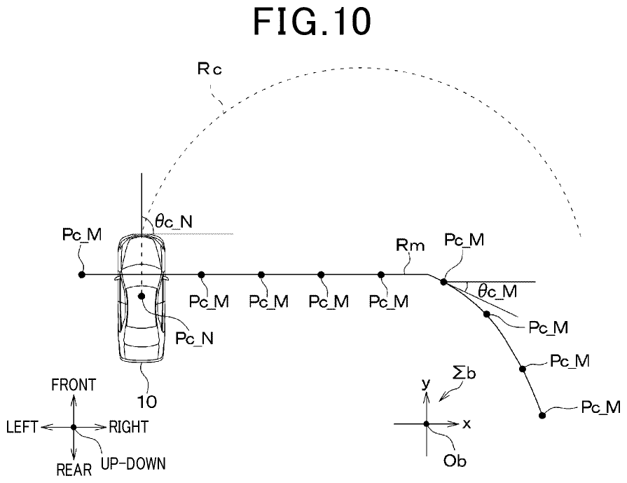

Here, as shown in FIG. 10, when a difference between the current angle θc_N and the stored angle θc_M is large, the vehicle 10 may move away from, rather than approach, the stored route Rm. In this case, the suggestion made by the vehicle suggestion apparatus 40 is highly likely to be unsuitable.

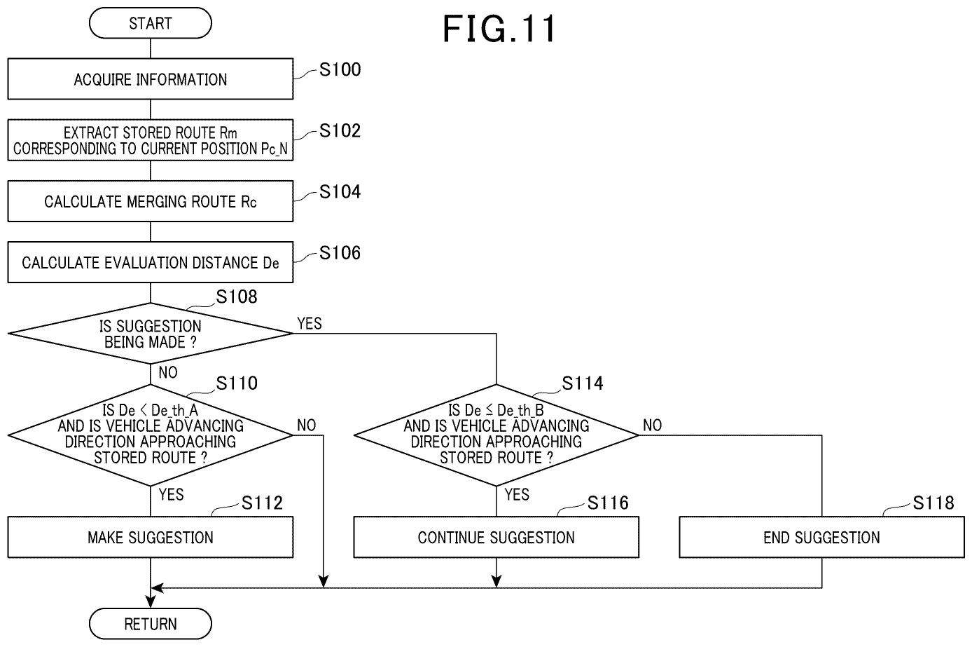

Therefore, at step S110 in a flowchart in FIG. 11, the vehicle suggestion apparatus 40 calculates a position of a tip end of the vehicle 10 on the advancing-direction side. Specifically, the vehicle suggestion apparatus 40 calculates the position of the tip end of the vehicle 10 on the advancing-direction side from a positional relationship between the current position Pc_N acquired at step S100, the vehicle position Pc set in advance, and a front end and a rear end of the vehicle 10. In addition, the vehicle suggestion apparatus 40 determines whether the tip end of the vehicle 10 is positioned on one side or another side of the stored route Rm based on the calculated position of the tip end of the vehicle 10 and the stored route Rm extracted at step S102.

Furthermore, the vehicle suggestion apparatus 40 calculates an angle difference Δθc from the current angle θc_N acquired at step S100 and the stored angle θc_M of the stored position Pc_M that is closest to the current position Pc_N corresponding to the current angle θc_N. The angle difference Δθc corresponds to an evaluation angle. In addition, a counter-clockwise direction of rotation around an axis extending in the up-down direction of the vehicle 10 is a positive direction of the angle. A clockwise direction of rotation around the axis extending in the up-down direction of the vehicle 10 is a negative direction of the angle.

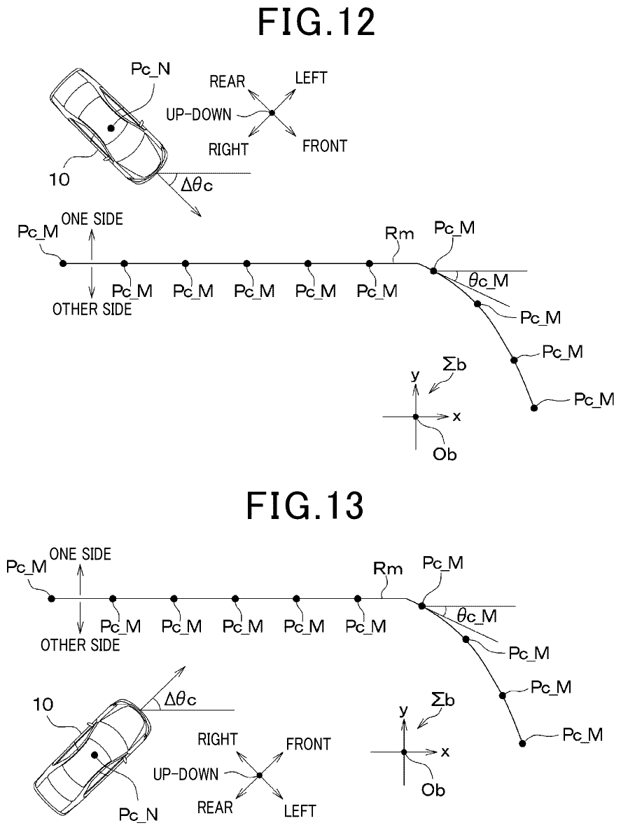

As shown in FIG. 12, when determined that the tip end of the vehicle 10 is positioned on one side of the stored route Rm, the vehicle suggestion apparatus 40 determines whether the angle difference Δθc is equal to or greater than a first evaluation angle threshold Δθc_th1_A, and less than zero. In addition, as shown in FIG. 13, when determined that the tip end of the vehicle 10 is positioned on the other side of the stored route Rm, the vehicle suggestion apparatus 40 determines whether the angle difference Δθc is equal to or greater than zero, and equal to or less than a second evaluation angle threshold Δθc_th2_A. The vehicle suggestion apparatus 40 thereby determines whether the advancing direction of the vehicle 10 is a direction approaching the stored route Rm. Here, the first evaluation angle threshold Δθc_th1_A and the second evaluation angle threshold Δθc_th2_A are set by experiments, simulations, and the like, such that whether the advancing direction of the vehicle 10 is the direction approaching the stored route Rm is determined.

As shown in FIG. 12, the angular difference Δθc being equal to or greater than the first evaluation angle threshold Δθc_th1_A, and less than zero when the tip end of the vehicle 10 is positioned on one side of the stored route Rm is assumed. At this time, the vehicle suggestion apparatus 40 determines that the advancing direction of the vehicle 10 is the direction approaching the stored route Rm. In addition, the angular difference Δθc being less than the first evaluation angle threshold Δθc_th1_A when the tip end of the vehicle 10 is positioned on one side of the stored route Rm is assumed. At this time, the vehicle suggestion apparatus 40 determines that the advancing direction of the vehicle 10 is not the direction approaching the stored route Rm, that is, the advancing direction of the vehicle 10 is a direction away from the stored route Rm. Furthermore, when determined that the angular difference Δθc is equal to or greater than zero when the tip end of the vehicle 10 is positioned on one side of the stored route Rm, the vehicle suggestion apparatus 40 determines that the advancing direction of the vehicle 10 is the direction away from the stored route Rm. As shown in FIG. 13, the angle difference Δθc being equal to or greater than zero, and equal to or less than the second evaluation angle threshold Δθc_th2_A when the tip end of the vehicle 10 is positioned on the other side of the stored route Rm is assumed. At this time, the vehicle suggestion apparatus 40 determines that the advancing direction of the vehicle 10 is the direction approaching the stored route Rm. In addition, when determined that the angular difference Δθc is less than zero when the tip end of the vehicle 10 is positioned on the other side of the stored route Rm, the vehicle suggestion apparatus 40 determines that the advancing direction of the vehicle 10 is the direction away from the stored route Rm. Furthermore, when determined that the angle difference Δθc is greater than the second evaluation angle threshold Δθc_th2_A when the tip end of the vehicle 10 is positioned on the other side of the stored route Rm, the vehicle suggestion apparatus 40 determines that the advancing direction of the vehicle 10 is the direction away from the stored route Rm.

Moreover, the vehicle suggestion apparatus 40 determines whether the evaluation distance De calculated at step S106 is less than the evaluation distance threshold De_th_A, and the advancing direction of the vehicle 10 is the direction approaching the stored route Rm. The vehicle suggestion apparatus 40 thereby determines whether to make the suggestion to automatically control the behavior of the vehicle 10.

When determined that the evaluation distance De is equal to or greater than the evaluation distance threshold De_th_A, the vehicle suggestion apparatus 40 determines that the suggestion to automatically control the behavior of the vehicle 10 is not to be made. Subsequently, the process performed by the vehicle suggestion apparatus 40 returns to step S100. In addition, when determined that the advancing direction of the vehicle 10 is the direction away from the stored route Rm, the vehicle suggestion apparatus 40 determines that the suggestion to automatically control the behavior of the vehicle 10 is not to be made. Subsequently, the process performed by the vehicle suggestion apparatus 40 returns to step S100. When determined that the evaluation distance De is less than the evaluation distance threshold De_th_A, and the vehicle 10 is traveling in the direction approaching the stored route Rm, the vehicle suggestion apparatus 40 determines that the suggestion to automatically control the behavior of the vehicle 10 is to be made. Subsequently, the process performed by the vehicle suggestion apparatus 40 proceeds to step S112. The process at step S112 is performed in a manner similar to that according to the first embodiment.

At step S114 following step S108, while the suggestion at step S112 is being made, the vehicle suggestion apparatus 40 calculates the position of the tip end of the vehicle 10 on the advancing-direction side in a manner similar to that described above. In addition, the vehicle suggestion apparatus 40 determines whether the tip end of the vehicle 10 is positioned on one side or another side of the stored route Rm based on the calculated position of the tip end of the vehicle 10 and the stored route Rm extracted at step S102.

The vehicle suggestion apparatus 40 also calculates the angle difference Δθc in a manner similar to that described above. In addition, when the tip end of the vehicle 10 is positioned on one side of the stored route Rm, the vehicle suggestion apparatus 40 determines whether the angle difference Δθc is equal to or greater than a first continuation angle threshold Δθc_th1_B, and less than zero. Furthermore, when the tip end of the vehicle 10 is positioned on the other side of the stored route Rm, the vehicle suggestion apparatus 40 determines whether the angle difference Δθc is greater than zero, and equal to or less than a second continuation angle threshold Δθc_th2_B. The vehicle suggestion apparatus 40 thereby determines whether the advancing direction of the vehicle 10 is the direction approaching the stored route Rm. The first continuation angle threshold Δθc_th1_B is less than the first evaluation angle threshold Δθc_th1_A. Therefore, continuation of the suggestion, described hereafter, is made easier by the first continuation angle threshold Δθc_th1_B. In addition, the second continuation angle threshold Δθc_th2_B is greater than the second evaluation angle threshold Δθc_th2_A. Therefore, continuation of the suggestion, described hereafter, is made easier by the second continuation angle threshold Δθc_th2_B. Thus, the first continuation angle threshold Δθc_th1_B and the second continuation angle threshold Δθc_th2_B are set by experiments, simulations, and the like, such that continuation of the suggestion is made easier.

When determined that the angle difference Δθc is equal to or greater than the first continuation angle threshold Δθc_th1_B, and less than zero when the tip end of the vehicle 10 is positioned on one side of the stored route Rm, the vehicle suggestion apparatus 40 determines that the advancing direction of the vehicle 10 is the direction approaching the stored route Rm. In addition, when determined that the angle difference Δθc is less than the first continuation angle threshold Δθc_th1_B when the tip end of the vehicle 10 is positioned on one side of the stored route Rm, the vehicle suggestion apparatus 40 determines that the advancing direction of the vehicle 10 is the direction away from the stored route Rm. Furthermore, when determined that the angular difference Δθc is equal to or greater than zero when the tip end of the vehicle 10 is positioned on one side of the stored route Rm, the vehicle suggestion apparatus 40 determines that the advancing direction of the vehicle 10 is the direction away from the stored route Rm. When determined that the angle difference Δθc is greater than zero, and equal to or less than the second continuation angle threshold Δθc_th2_B when the tip end of the vehicle 10 is positioned on the other side of the stored route Rm, the vehicle suggestion apparatus 40 determines that the advancing direction of the vehicle 10 is the direction approaching the stored route Rm. In addition, when determined that the angular difference Δθc is equal to or less than zero when the tip end of the vehicle 10 is positioned on the other side of the stored route Rm, the vehicle suggestion apparatus 40 determines that the advancing direction of the vehicle 10 is the direction away from the stored route Rm. Furthermore, when determined that the angle difference Δθc is greater than the second continuation angle threshold Δθc_th2_B when the tip end of the vehicle 10 is positioned on the other side of the stored route Rm, the vehicle suggestion apparatus 40 determines that the advancing direction of the vehicle 10 is the direction away from the stored route Rm.

The vehicle suggestion apparatus 40 determines whether the evaluation distance De calculated at step S106 is equal to or less than the continuation distance threshold De_th_B, and the advancing direction of the vehicle 10 is the direction approaching the stored route Rm. The vehicle suggestion apparatus 40 thereby determines whether the suggestion to automatically control the behavior of the vehicle 10 is to be made.

When determined that the evaluation distance De is greater than the continuation distance threshold De_th_B, the vehicle suggestion apparatus 40 determines that the suggestion that is being made is to be ended. Subsequently, the process performed by the vehicle suggestion apparatus 40 proceeds to step S118. The process at step S118 is performed in a manner similar to that according to the first embodiment. When determined that the advancing direction of the vehicle 10 is the direction away from the stored route Rm, the vehicle suggestion apparatus 40 determines that the suggestion that is being made is to be ended. Subsequently, the process performed by the vehicle suggestion apparatus 40 proceeds to step S118. The process at step S118 is performed in a manner similar to that according to the first embodiment. When determined that the evaluation distance De is equal to or less than the continuation distance threshold De_th_B, and the advancing direction of the vehicle 10 is the direction approaching the stored route Rm, the vehicle suggestion apparatus 40 determines that the suggestion that is being made is to be continued. Subsequently, the process performed by the vehicle suggestion apparatus 40 proceeds to step S116. The process at step S116 is performed in a manner similar to that according to the first embodiment.

The vehicle suggestion apparatus 40 according to the second embodiment performs the processes in the manner described above. According to the second embodiment as well, effects similar to those according to the first embodiment are achieved. In addition, according to the second embodiment, the suggestion by the vehicle suggestion apparatus 40 is not made when the difference between the current angle θc_N and the stored angle θc_M is large. Therefore, the suggestion made by the vehicle suggestion apparatus 40 becoming unsuitable is suppressed.

### Third Embodiment

According to a third embodiment, form of the evaluation distance De differs from that according to the first embodiment. Therefore, the process at step S106 of the vehicle suggestion apparatus 40 differs from that according to the first embodiment. Other configurations are similar to those according to the first embodiment.

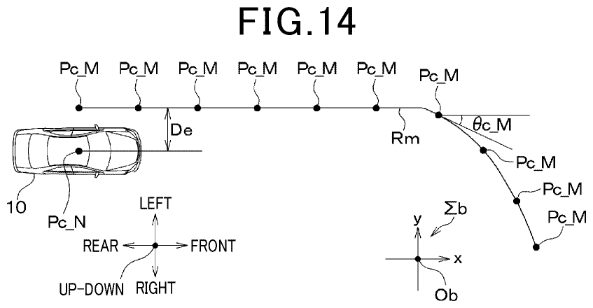

Specifically, as shown in FIG. 14, the evaluation distance De is set to a distance from the current position Pc_N to the stored position Pc_M that is closest to the current position Pc_N, instead of the distance from the merging route position Pr. The stored position Pc_M corresponding to the current position Pc_N is the stored position Pc_M closest to the current position Pc_N.

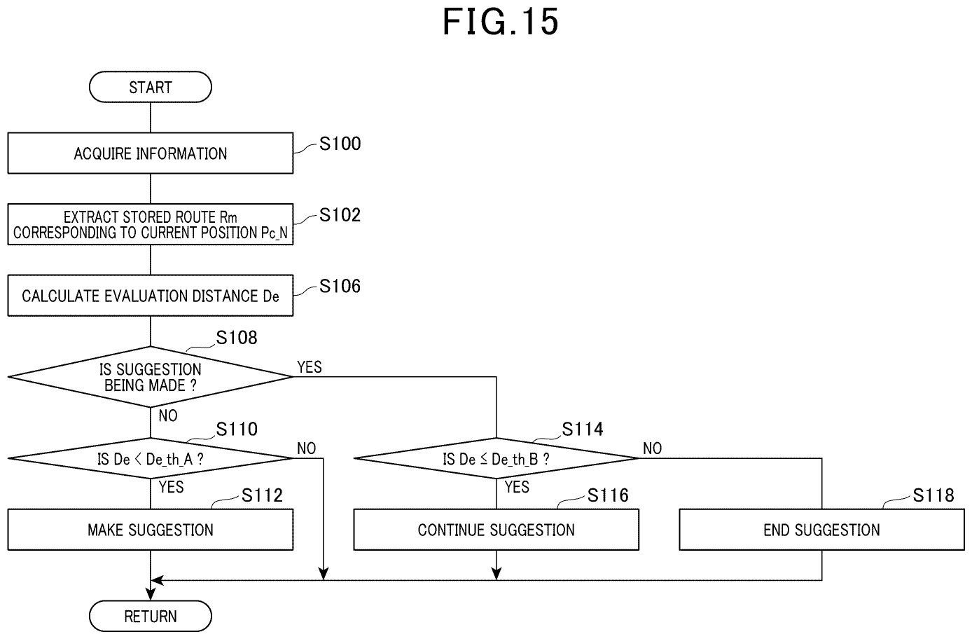

Therefore, the vehicle suggestion apparatus 40 does not perform the process at step S104, as shown in a flowchart in FIG. 15. At step S106 following step S102, the vehicle suggestion apparatus 40 uses the current position Pc_N acquired at step S100 and the stored route Rm extracted at step S102. The vehicle suggestion apparatus 40 thereby calculates the evaluation distance De. The processes at step S108 to step S118 following step S106 are performed in a manner similar to that according to the first embodiment.

The vehicle suggestion apparatus 40 according to the third embodiment performs the processes in the manner described above. According to the third embodiment as well, effects similar to those according to the first embodiment are achieved.

### Fourth Embodiment

According to a fourth embodiment, the processes of the vehicle suggestion apparatus 40 differ from those according to the first embodiment. Other configurations are similar to those according to the first embodiment.

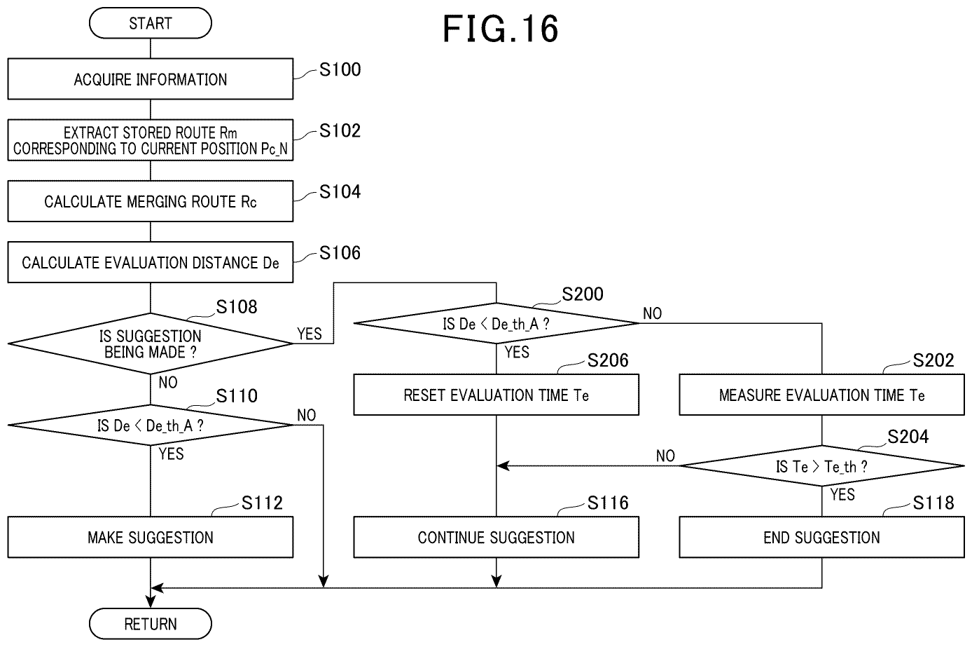

Specifically, the processes from step S100 to step S112 are performed in a manner similar to that according to the first embodiment, as shown in a flowchart in FIG. 16.

At step S200 following step S108, while the suggestion at step S112 is being made, the vehicle suggestion apparatus 40 determines whether the evaluation distance De calculated at step S106 is less than the evaluation distance threshold De_th_A.

When the evaluation distance De is less than the evaluation distance threshold De_th_A, the process performed by the vehicle suggestion apparatus 40 proceeds to step S206. In addition, when the evaluation distance De is equal to or greater than the evaluation distance threshold De_th_A, the process performed by the vehicle suggestion apparatus 40 proceeds to step S202.

At step S202 following step S200, the vehicle suggestion apparatus 40 measures an evaluation time Te. The evaluation time Te is an amount of time over which the evaluation distance De is equal to or greater than the evaluation distance threshold De_th_A.

At step S204 following step S202, the vehicle suggestion apparatus 40 determines whether the evaluation time Te calculated at step S202 is greater than a time threshold Te_th. The vehicle suggestion apparatus 40 thereby determines whether the suggestion that is being made is to be continued. The time threshold Te_th is set by experiments, simulations, and the like, such that the suggestion being made is easily continued and the duration of the suggestion being made is sufficient.

When the evaluation time Te is equal to or less than the time threshold Te_th, because the duration of the suggestion being made is short, the vehicle suggestion apparatus 40 determines that the suggestion that is being made is to be continued. Subsequently, the process performed by the vehicle suggestion apparatus 40 proceeds to step S116. The process at step S116 is performed in a manner similar to that according to the first embodiment. In addition, when the evaluation time Te is greater than the time threshold Te_th, the duration of the suggestion being made is sufficient. Therefore, the vehicle suggestion apparatus 40 determines that suggestion that is being made is to be ended. Subsequently, the process performed by the vehicle suggestion apparatus 40 proceeds to step S118. The process at step S118 is performed in a manner similar to that according to the first embodiment.

At step S206 following step S200, the vehicle suggestion apparatus 40 may set the evaluation time Te calculated at step S202 to, for example, zero. The vehicle suggestion apparatus 40 thereby resets the evaluation time Te calculated at step S202. Subsequently, the process performed by the vehicle suggestion apparatus 40 proceeds to step S116. The process at step S116 is performed in a manner similar to that according to the first embodiment.

The vehicle suggestion apparatus 40 according to the fourth embodiment performs the processes in the manner described above. According to the fourth embodiment as well, effects similar to those according to the first embodiment are achieved.

### Fifth Embodiment

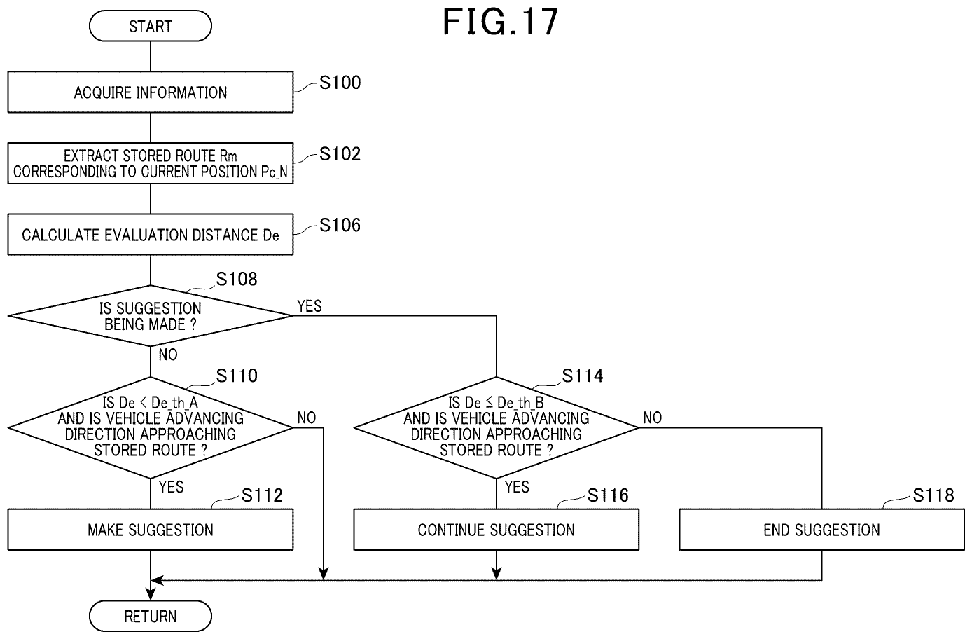

A fifth embodiment is a combination of the second embodiment and the third embodiment. Therefore, the angle difference Δθc is used to make and continue the suggestion. In addition, the evaluation distance De is set to the distance from the current position Pc_N to the stored position Pc_M that is closest to the current position Pc_N, instead of the distance from the merging route position Pr. Therefore, the vehicle suggestion apparatus 40 does not perform the process at step S104, as shown in a flowchart in FIG. 17. Thus, at step S106 following step S102, the vehicle suggestion apparatus 40 uses the current position Pc_N acquired at step S100 and the stored route Rm extracted at step S102. The vehicle suggestion apparatus 40 thereby calculates the evaluation distance De. The processes at step S108 to S118 following step S106 are performed in a manner similar to that according to the second embodiment.

According to the fifth embodiment as well, effects similar to those according to the second embodiment and the third embodiment are achieved.

### Sixth Embodiment

According to a sixth embodiment, the form of the evaluation distance De differs from that according to the first embodiment. Therefore, the process at step S106 of the vehicle suggestion apparatus 40 differs from that according to the first embodiment. Other configurations are similar to those according to the fourth embodiment.

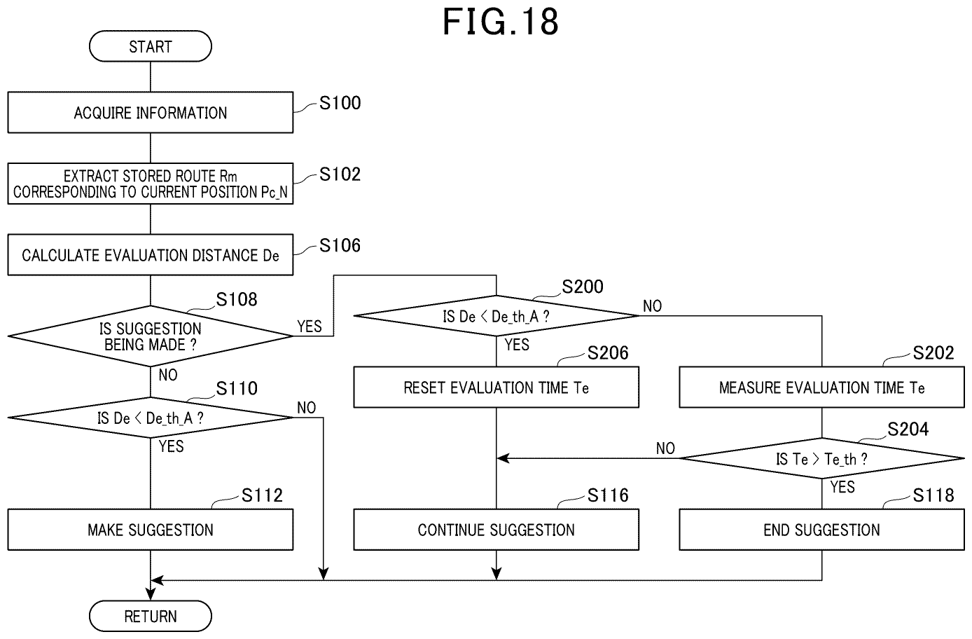

Specifically, the evaluation distance De is set to the distance from the current position Pc_N to the stored position Pc_M that is closest to the current position Pc_N, instead of the distance from the merging route position Pr. Therefore, the vehicle suggestion apparatus 40 does not perform the process at step S104, as shown in a flowchart in FIG. 18. Thus, at step S106 following step S102, the vehicle suggestion apparatus 40 uses the current position Pc_N acquired at step S100 and the stored route Rm extracted at step S102. The vehicle suggestion apparatus 40 thereby calculates the evaluation distance De. The process following step S106 is performed in a manner similar to that according to the fourth embodiment.

The vehicle suggestion apparatus 40 according to the sixth embodiment performs the processes in the manner described above. According to the sixth embodiment as well, effects similar to those according to the fourth embodiment are achieved.

### Other Embodiment

The present disclosure is not limited to the above-described embodiments, and the above-described embodiments can be modified as appropriate. In addition, it goes without saying that an element configuring the above-described embodiments is not necessarily a requisite unless particularly specified as being a requisite, clearly considered a requisite in principle, or the like.

An acquiring unit, a suggesting unit, a continuing unit, and the like, and a method thereof described in the present disclosure may be actualized by a dedicated computer that is provided such as to be configured by a processor and a memory, the processor being programmed to provide one or a plurality of functions that are realized by a computer program. Alternatively, the acquiring unit, the suggesting unit, the continuing unit, and the like, and a method thereof described in the present disclosure may be actualized by a dedicated computer that is provided by a processor being configured by a single dedicated hardware logic circuit or more. As another alternative, the acquiring unit, the suggesting unit, the continuing unit, and the like, and a method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. In addition, the computer program may be stored in a non-transitory, computer-readable, tangible storage medium that can be read by a computer as instructions performed by the computer.

According to the above-described first embodiment, when determined that the evaluation distance De is greater than the continuation distance threshold De_th_B while the suggestion at step S112 is being made, the vehicle suggestion apparatus 40 ends the suggestion that is being made.

In contrast, the vehicle suggestion apparatus 40 may end the suggestion that is being made when the driver of the vehicle 10 does not carry out the content of the suggestion for a certain period of time while the suggestion at step S112 is being made. In addition, the vehicle suggestion apparatus 40 may end the suggestion that is being made when the driver of the vehicle 10 presses a suggestion end switch while the suggestion at step S112 is being made. Furthermore, the vehicle suggestion apparatus 40 may end the suggestion that is being made when the driver of the vehicle 10 shows no intention of carrying out the content of the suggestion, such as when the driver of the vehicle 10 accelerates the vehicle 10, while the suggestion at step S112 is being made.

According to the above-described embodiments, the reference line related to the vehicle angle θc is a straight line that is parallel to the x-axis. However, the reference line for the vehicle angle θc is not limited to being a straight line that is parallel to the x-axis, and may be, for example, a straight line that is parallel to the y-axis.

The above-described embodiments may be combined as appropriate.

### ASPECTS OF THE PRESENT DISCLOSURE

### Aspect 1

A vehicle suggestion apparatus, including: at least one of (i) a circuit and (ii) a processor with a memory storing computer program code executable by the processor, the at least one of the circuit and the processor configured to implement: an acquiring unit (S100, S102, S104) that acquires stored data (Md) including a stored route (Rm) that is a route stored when a vehicle (10) is traveling, and a merging route (Rc) that is a route that merges the vehicle onto the stored route from a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and a continuing unit (S114, S116) that continues the suggestion in response to the evaluation distance being equal to or less than a continuation distance threshold (De_th_B) that is greater than the evaluation distance threshold, while the suggestion is being made.

### Aspect 2

A vehicle suggestion apparatus, including: at least one of (i) a circuit and (ii) a processor with a memory storing computer program code executable by the processor, the at least one of the circuit and the processor configured to implement: an acquiring unit (S100, S102) that acquires stored data (Md) including a stored route (Rm) that is a route stored when a vehicle (10) is traveling, and a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from the current position to a position (Pc_M) on the stored route closest to the current position; and a continuing unit (S114, S116) that continues the suggestion in response to the evaluation distance being equal to or less than a continuation distance threshold (De_th_B) that is greater than the evaluation distance threshold, while the suggestion is being made.

### Aspect 3

The vehicle suggestion apparatus according to the aspect 1 or 2, in which: the continuing unit ends the suggestion in response to the evaluation distance being greater than the continuation distance threshold, while the suggestion is being made.

### Aspect 4

The vehicle suggestion apparatus according to the aspect 2 or 3, in which: the stored data includes a stored angle (θc_M) that is an angle formed by a reference line (x) extending in a direction perpendicular to an up-down direction of the vehicle, and a straight line extending in a direction perpendicular to the up-down direction and in an advancing direction of the vehicle, and is an angle of the vehicle when the vehicle is traveling the stored route; the acquiring unit acquires a current angle (θc_N) that is an angle formed by the reference line and the straight line, and is a current angle of the vehicle; the suggesting unit, when a tip end of the vehicle on the advancing direction-side is positioned on one side relative to the stored route, makes the suggestion in response to an evaluation angle (Δθc) being equal to or greater than a first evaluation angle threshold (Δθc_th1_A), and less than zero, the evaluation angle being a difference between the current angle and the stored angle in a position on the stored route closest to the current position corresponding to the current angle, and when the tip is positioned on another side relative to the stored route, makes the suggestion in response to the evaluation angle being greater than zero, and equal to or less than a second evaluation angle threshold (Δθc_th2_A); the continuing unit, when the suggestion is being made, continues the suggestion in response to the tip end being positioned on one side relative to the stored route and the evaluation angle being equal to or greater than a first continuation angle threshold (Δθc_th2_B) that is less than the first evaluation angle threshold, and less than zero, and continues the suggestion in response to the tip end being positioned on the other side relative to the stored route and the evaluation angle being greater than zero, and equal to or less than a second continuation angle threshold (Δθc_th2_B) that is greater than the second evaluation angle threshold.

### Aspect 5

The vehicle suggestion apparatus according to the aspect 4, in which: the continuing unit, when the suggestion is being made, ends the suggestion in response to the tip end being positioned on one side relative to the stored route and the evaluation angle being less than the first continuation angle threshold, ends the suggestion in response to the tip end being positioned on one side relative to the stored route and the evaluation angle being equal to or greater than zero, ends the suggestion in response to the tip end being positioned on the other side relative to the stored route and the evaluation angle being equal to or less than zero, and ends the suggestion in response to the tip end being positioned on the other side relative to the stored route and the evaluation angle being greater than the second continuation angle threshold.

### Aspect 6

A vehicle suggestion apparatus, including: at least one of (i) a circuit and (ii) a processor with a memory storing computer program code executable by the processor, the at least one of the circuit and the processor configured to implement: an acquiring unit (S100, S102, S104) that acquires stored data (Md) including a stored route (Rm) that is a route stored when a vehicle (10) is traveling, and a merging route (Rc) that is a route that merges the vehicle onto the stored route from a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and a continuing unit (S116, S200, S202, S204) that continues the suggestion in response to an evaluation time (Te) being equal to or less than a time threshold (Te_th), the evaluation time being an amount of time over which the evaluation distance is equal to or greater than the evaluation distance threshold, while the suggestion is being made.

### Aspect 7

A vehicle suggestion apparatus, including: at least one of (i) a circuit and (ii) a processor with a memory storing computer program code executable by the processor, the at least one of the circuit and the processor configured to implement: an acquiring unit (S100, S102) that acquires stored data (Md) including a stored route (Rm) that is a route stored when a vehicle (10) is traveling, and a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from the current position to a position (Pc_M) on the stored route closest to the current position; and a continuing unit (S116, S200, S202, S204) that continues the suggestion in response to an evaluation time (Te) being equal to or less than a time threshold (Te_th), the evaluation time being an amount of time over which the evaluation distance is equal to or greater than the evaluation distance threshold, while the suggestion is being made.

### Aspect 8

The vehicle suggestion apparatus according to the aspect 6 or 7, in which: the continuing unit ends the suggestion when the evaluation time is greater than the time threshold while the suggestion is being made.

### Aspect 9

A vehicle suggestion method, comprising:
acquiring (S100, S102, S104) stored data (Md) including a stored route (Rm) that is a route stored when a vehicle (10) is traveling, and a merging route (Rc) that is a route that merges the vehicle onto the stored route from a current position (Pc_N) of the vehicle;
making (S110, S112) a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and
continuing (S114, S116) the suggestion in response to the evaluation distance being equal to or less than a continuation distance threshold (De_th_B) that is greater than the evaluation distance threshold, while the suggestion is being made.

### Aspect 10

10. A vehicle suggestion method, comprising:
acquiring (S100, S102) stored data (Md) including a stored route (Rm) that is a route stored when a vehicle (10) is traveling, and a current position (Pc_N) of the vehicle;
making (S110, S112) a suggestion to automatically control a behavior of the vehicle in response to an evaluation distance (De) being less than an evaluation distance threshold (De_th_A), the evaluation distance being a distance from the current position to a position (Pc_M) on the stored route closest to the current position; and
continuing (S114, S116) the suggestion in response to the evaluation distance being equal to or less than a continuation distance threshold (De_th_B) that is greater than the evaluation distance threshold, while the suggestion is being made.

### Aspect 11

A vehicle suggestion method, including: acquiring (S100, S102, S104) stored data (Md) including a stored route (Rm) that is a route stored when a vehicle (10) is traveling, and a merging route (Rc) that is a route that merges the vehicle onto the stored route from a current position (Pc_N) of the vehicle; making (S110, S112) a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and continuing (S116, S200, S202, S204) the suggestion in response to an evaluation time (Te) being equal to or less than a time threshold (Te_th), the evaluation time being an amount of time over which the evaluation distance is equal to or greater than the evaluation distance threshold, while the suggestion is being made.

### Aspect 12

A vehicle suggestion method, including: acquiring (S100, S102) stored data (Md) including a stored route (Rm) that is a route stored when a vehicle (10) is traveling, and a current position (Pc_N) of the vehicle; making (S110, S112) a suggestion to automatically control a behavior of the vehicle in response to an evaluation distance (De) being less than an evaluation distance threshold (De_th_A), the evaluation distance being a distance from the current position to a position (Pc_M) on the stored route closest to the current position; and continuing (S116, S200, S202, S204) the suggestion in response to an evaluation time (Te) being equal to or less than a time threshold (Te_th), the evaluation time being an amount of time over which the evaluation distance is equal to or greater than the evaluation distance threshold, while the suggestion is being made.

### Aspect 13

A non-transitory computer-readable storage medium storing therein a vehicle suggestion program causing a vehicle suggestion apparatus to provide functions including: an acquiring unit (S100, S102, S104) that acquires stored data (Md) including a stored route (Rm) that is a route stored when a vehicle (10) is traveling, and a merging route (Rc) that is a route that merges the vehicle onto the stored route from a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and a continuing unit (S114, S116) that continues the suggestion in response to the evaluation distance being equal to or less than a continuation distance threshold (De_th_B) that is greater than the evaluation distance threshold, while the suggestion is being made.

### Aspect 14

A non-transitory computer-readable storage medium storing therein a vehicle suggestion program causing a vehicle suggestion apparatus to provide functions including: an acquiring unit (S100, S102) that acquires stored data (Md) including a stored route (Rm) that is a route stored when a vehicle (10) is traveling, and a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from the current position to a position (Pc_M) on the stored route closest to the current position; and a continuing unit (S114, S116) that continues the suggestion in response to the evaluation distance being equal to or less than a continuation distance threshold (De_th_B) that is greater than the evaluation distance threshold, while the suggestion is being made.

### Aspect 15

A non-transitory computer-readable storage medium storing therein a vehicle suggestion program causing a vehicle suggestion apparatus to provide functions including: an acquiring unit (S100, S102, S104) that acquires stored data (Md) including a stored route (Rm) that is a route stored when a vehicle (10) is traveling, and a merging route (Rc) that is a route that merges the vehicle onto the stored route from a current position (Pc_N) of the vehicle; a suggesting unit (S110, S112) that makes a suggestion to automatically control a behavior of the vehicle in response to an evaluation distance (De) being less than an evaluation distance threshold (De_th_A), the evaluation distance being a distance from a position (Pr) on the merging route to a position (Pc_M) on the stored route closest to the position on the merging route; and a continuing unit (S116, S200, S202, S204) that continues the suggestion when an evaluation time (Te) is equal to or less than a time threshold (Te_th), the evaluation time being an amount of time over which the evaluation distance is equal to or greater than the evaluation distance threshold, while the suggestion is being made.

### Aspect 16

A non-transitory computer-readable storage medium storing therein a vehicle suggestion program causing a vehicle suggestion apparatus to provide functions including: an acquiring unit (S100, S102) that acquires stored data (Md) including a stored route (Rm) that is a route stored when a vehicle (10) is traveling, and a current position (Pc_N) of the vehicle; a suggesting unit (S110, S112) that makes a suggestion to automatically control a behavior of the vehicle when an evaluation distance (De) is less than an evaluation distance threshold (De_th_A), the evaluation distance being a distance from the current position to a position (Pc_M) on the stored route closest to the current position; and a continuing unit (S116, S200, S202, S204) that continues the suggestion in response to an evaluation time (Te) being equal to or less than a time threshold (Te_th), the evaluation time being an amount of time over which the evaluation distance is equal to or greater than the evaluation distance threshold, while the suggestion is being made.

What is claimed is:

1. A vehicle suggestion apparatus, comprising:
at least one of (i) a circuit and (ii) a processor with a memory storing computer program code executable by the processor, the at least one of the circuit and the processor configured to implement:
an acquiring unit that acquires stored data including a stored route that is a route stored when a vehicle is traveling, and a merging route that is a route that merges the vehicle onto the stored route from a current position of the vehicle;
a suggesting unit that makes a suggestion to automatically control a behavior of the vehicle in response to an evaluation distance being less than an evaluation distance threshold, the evaluation distance being a distance from a position on the merging route to a position on the stored route closest to the position on the merging route; and
a continuing unit that continues the suggestion in response to the evaluation distance being equal to or less than a continuation distance threshold that is greater than the evaluation distance threshold, while the suggestion is being made.

2. A vehicle suggestion apparatus, comprising:
at least one of (i) a circuit and (ii) a processor with a memory storing computer program code executable by the processor, the at least one of the circuit and the processor configured to implement:
an acquiring unit that acquires stored data including a stored route that is a route stored when a vehicle is traveling, and a current position of the vehicle;
a suggesting unit that makes a suggestion to automatically control a behavior of the vehicle in response to an evaluation distance being less than an evaluation distance threshold, the evaluation distance being a distance from the current position to a position on the stored route closest to the current position; and
a continuing unit that continues the suggestion in response to the evaluation distance being equal to or less than a continuation distance threshold that is greater than the evaluation distance threshold, while the suggestion is being made.

3. The vehicle suggestion apparatus according to claim 1, wherein:
the continuing unit ends the suggestion in response to the evaluation distance being greater than the continuation distance threshold, while the suggestion is being made.

4. The vehicle suggestion apparatus according to claim 2, wherein:
the continuing unit ends the suggestion in response to the evaluation distance being greater than the continuation distance threshold, while the suggestion is being made.

5. The vehicle suggestion apparatus according to claim 2, wherein:
the stored data includes a stored angle that is an angle formed by a reference line extending in a direction perpendicular to an up-down direction of the vehicle, and a straight line extending in a direction perpendicular to the up-down direction and in an advancing direction of the vehicle, and is an angle of the vehicle when the vehicle is traveling the stored route;
the acquiring unit acquires a current angle that is an angle formed by the reference line and the straight line, and is a current angle of the vehicle;
the suggesting unit,
when a tip end of the vehicle on the advancing direction-side is positioned on one side relative to the stored route,
makes the suggestion in response to an evaluation angle being equal to or greater than a first evaluation angle threshold, and less than zero, the evaluation angle being a difference between the current angle and the stored angle in a position on the stored route closest to the current position corresponding to the current angle, and
when the tip is positioned on another side relative to the stored route,
makes the suggestion in response to the evaluation angle being greater than zero, and equal to or less than a second evaluation angle threshold;
the continuing unit,
when the suggestion is being made,
continues the suggestion in response to the tip end being positioned on one side relative to the stored route and the evaluation angle being equal to or greater than a first continuation angle threshold that is less than the first evaluation angle threshold, and less than zero, and
continues the suggestion in response to the tip end being positioned on the other side relative to the stored route and the evaluation angle being greater than zero, and equal to or less than a second continuation angle threshold that is greater than the second evaluation angle threshold.

6. The vehicle suggestion apparatus according to claim 5, wherein:
the continuing unit
when the suggestion is being made,
ends the suggestion in response to the tip end being positioned on one side relative to the stored route and the evaluation angle being less than the first continuation angle threshold,
ends the suggestion in response to the tip end being positioned on one side relative to the stored route and the evaluation angle being equal to or greater than zero,
ends the suggestion in response to the tip end being positioned on the other side relative to the stored route and the evaluation angle being equal to or less than zero, and
ends the suggestion in response to the tip end being positioned on the other side relative to the stored route and the evaluation angle being greater than the second continuation angle threshold.

7. A vehicle suggestion apparatus, comprising:
at least one of (i) a circuit and (ii) a processor with a memory storing computer program code executable by the processor, the at least one of the circuit and the processor configured to implement:
an acquiring unit that acquires stored data including a stored route that is a route stored when a vehicle is traveling, and a merging route that is a route that merges the vehicle onto the stored route from a current position of the vehicle;
a suggesting unit that makes a suggestion to automatically control a behavior of the vehicle in response to an evaluation distance being less than an evaluation distance threshold, the evaluation distance being a distance from a position on the merging route to a position on the stored route closest to the position on the merging route; and
a continuing unit that continues the suggestion in response to an evaluation time being equal to or less than a time threshold, the evaluation time being an amount of time over which the evaluation distance is equal to or greater than the evaluation distance threshold, while the suggestion is being made.

8. A vehicle suggestion apparatus, comprising:
at least one of (i) a circuit and (ii) a processor with a memory storing computer program code executable by the processor, the at least one of the circuit and the processor configured to implement:
an acquiring unit that acquires stored data including a stored route that is a route stored when a vehicle is traveling, and a current position of the vehicle;
a suggesting unit that makes a suggestion to automatically control a behavior of the vehicle in response to an evaluation distance being less than an evaluation distance threshold, the evaluation distance being a distance from the current position to a position on the stored route closest to the current position; and
a continuing unit that continues the suggestion in response to an evaluation time being equal to or less than a time threshold, the evaluation time being an amount of time over which the evaluation distance is equal to or greater than the evaluation distance threshold, while the suggestion is being made.

9. The vehicle suggestion apparatus according to claim 7, wherein:
the continuing unit ends the suggestion when the evaluation time is greater than the time threshold while the suggestion is being made.

10. The vehicle suggestion apparatus according to claim 8, wherein:
the continuing unit ends the suggestion when the evaluation time is greater than the time threshold while the suggestion is being made.

11. A vehicle suggestion method, comprising:
acquiring stored data including a stored route that is a route stored when a vehicle is traveling, and a merging route that is a route that merges the vehicle onto the stored route from a current position of the vehicle;
making a suggestion to automatically control a behavior of the vehicle in response to an evaluation distance being less than an evaluation distance threshold, the evaluation distance being a distance from a position on the merging route to a position on the stored route closest to the position on the merging route; and
continuing the suggestion in response to the evaluation distance being equal to or less than a continuation distance threshold that is greater than the evaluation distance threshold, while the suggestion is being made.

12. A vehicle suggestion method, comprising:
acquiring stored data including a stored route that is a route stored when a vehicle is traveling, and a current position of the vehicle;
making a suggestion to automatically control a behavior of the vehicle in response to an evaluation distance being less than an evaluation distance threshold, the evaluation distance being a distance from the current position to a position on the stored route closest to the current position; and
continuing the suggestion in response to the evaluation distance being equal to or less than a continuation distance threshold that is greater than the evaluation distance threshold, while the suggestion is being made.

13. A vehicle suggestion method, comprising:
acquiring stored data including a stored route that is a route stored when a vehicle is traveling, and a merging route that is a route that merges the vehicle onto the stored route from a current position of the vehicle;
making a suggestion to automatically control a behavior of the vehicle in response to an evaluation distance being less than an evaluation distance threshold, the evaluation distance being a distance from a position on the merging route to a position on the stored route closest to the position on the merging route; and
continuing the suggestion in response to an evaluation time being equal to or less than a time threshold, the evaluation time being an amount of time over which the evaluation distance is equal to or greater than the evaluation distance threshold, while the suggestion is being made.

14. A vehicle suggestion method, comprising:
acquiring stored data including a stored route that is a route stored when a vehicle is traveling, and a current position of the vehicle;
making a suggestion to automatically control a behavior of the vehicle in response to an evaluation distance being less than an evaluation distance threshold, the evaluation distance being a distance from the current position to a position on the stored route closest to the current position; and
continuing the suggestion in response to an evaluation time being equal to or less than a time threshold, the evaluation time being an amount of time over which the evaluation distance is equal to or greater than the evaluation distance threshold, while the suggestion is being made.

15. A non-transitory computer-readable storage medium storing therein a vehicle suggestion program causing a vehicle suggestion apparatus to provide functions comprising:
an acquiring unit that acquires stored data including a stored route that is a route stored when a vehicle is traveling, and a merging route that is a route that merges the vehicle onto the stored route from a current position of the vehicle;
a suggesting unit that makes a suggestion to automatically control a behavior of the vehicle in response to an evaluation distance being less than an evaluation distance threshold, the evaluation distance being a distance from a position on the merging route to a position on the stored route closest to the position on the merging route; and
a continuing unit that continues the suggestion in response to the evaluation distance being equal to or less than a continuation distance threshold that is greater than the evaluation distance threshold, while the suggestion is being made.

16. A non-transitory computer-readable storage medium storing therein a vehicle suggestion program causing a vehicle suggestion apparatus to provide functions comprising:
an acquiring unit that acquires stored data including a stored route that is a route stored when a vehicle is traveling, and a current position of the vehicle;
a suggesting unit that makes a suggestion to automatically control a behavior of the vehicle in response to an evaluation distance being less than an evaluation distance threshold, the evaluation distance being a distance from the current position to a position on the stored route closest to the current position; and
a continuing unit that continues the suggestion in response to the evaluation distance being equal to or less than a continuation distance threshold that is greater than the evaluation distance threshold, while the suggestion is being made.

17. A non-transitory computer-readable storage medium storing therein a vehicle suggestion program causing a vehicle suggestion apparatus to provide functions comprising:
an acquiring unit that acquires stored data including a stored route that is a route stored when a vehicle is traveling, and a merging route that is a route that merges the vehicle onto the stored route from a current position of the vehicle;
a suggesting unit that makes a suggestion to automatically control a behavior of the vehicle in response to an evaluation distance being less than an evaluation distance threshold, the evaluation distance being a distance from a position on the merging route to a position on the stored route closest to the position on the merging route; and
a continuing unit that continues the suggestion when an evaluation time is equal to or less than a time threshold, the evaluation time being an amount of time over which the evaluation distance is equal to or greater than the evaluation distance threshold, while the suggestion is being made.

18. A non-transitory computer-readable storage medium storing therein a vehicle suggestion program causing a vehicle suggestion apparatus to provide functions comprising:
an acquiring unit that acquires stored data including a stored route that is a route stored when a vehicle is traveling, and a current position of the vehicle;
a suggesting unit that makes a suggestion to automatically control a behavior of the vehicle when an evaluation distance is less than an evaluation distance threshold, the evaluation distance being a distance from the current position to a position on the stored route closest to the current position; and
a continuing unit that continues the suggestion in response to an evaluation time being equal to or less than a time threshold, the evaluation time being an amount of time over which the evaluation distance is equal to or greater than the evaluation distance threshold, while the suggestion is being made.
